(19) United States
(12) Patent Application Publication
(10) Pub. No.: US 2024/0365205 A1
(43) Pub. Date: Oct. 31, 2024

(54) SYSTEM AND METHOD FOR PERFORMING INGRESS/EGRESS ACTIVE -ACTIVE ROUTING IN 5G NETWORKS

(71) Applicant: JIO PLATFORMS LIMITED, Ahmedabad (IN)

(72) Inventors: Sandeep BISHT, Kalyan (IN); Ezaj Ahmed ANSARI, Darjeeling (IN); Ravindra Kumar YADAV, Orai (IN); Aayush BHATNAGAR, Navi Mumbai (IN)

(21) Appl. No.: 18/029,689

(22) PCT Filed: Mar. 24, 2023
(86) PCT No.: PCT/IB2023/052931

§ 371 Date: Mar. 31, 2023

(30) Foreign Application Priority Data
Mar. 31, 2022 (IN) 202221019663

(51) Int. Cl. H04W 40/00; H04W 40/02

(52) U.S. Cl. CPC H04W 40/005; H04W 40/02

(57) ABSTRACT

The present disclosure facilitates to connect network elements through internetwork communication links that enable routing with active and standby instances. For both the ingress/egress active-active routing, when a request to route traffic is obtained, it is determined whether any/at least one of an endpoint are active. If all the end points are found to be active, then the traffic may be equally divided amongst the nodes present within the active cluster. However, if some of the end points are found to be active, while others are found to be not active, then the traffic is equally divided amongst the active nodes present within the active cluster.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present invention relates to routing through network elements, such as routers, and more particularly to network elements connected through internetwork communication links that enable routing with active and standby instances.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Availability of fast and uninterrupted communication facility has become imperative in today's high-tech world. Many communication devices such as, smart phones, laptops, tablets, and the likes, are there in market for contending the requirement of fast and uninterrupted communication facility. These communication devices can be connected through various wired and wireless network technologies.

However, usage and number of the communication devices are increasing day-by-day at an exponential rate, which has resulted in increased complexity of the existing networks. This may lead to poor service quality, security, and efficiency in the current communication networks. In such a scenario, a router acts as a primary control point, which aids in casing out the increasing complexities of the networks, provides reliable service quality and security, facilitates monitoring and improvement in efficiency, and other attributes that allow networks to add value. Therefore, by controlling a router one can control, to a great extent, corresponding network.

In general, routing can be defined as a mechanism of selecting a specific path in a network or between or across multiple networks for transmitting data quickly between a first communication device and a second communication device, which may be located remotely from each other. Routing can be performed on various networks including circuit-switched networks, for instance, public switched telephone network (PSTN), as well as computer networks, for instance, Internet.

In the routing process, routing tables are frequently used to direct the forwarding of data packets. Routing tables keep track of the paths to different network destinations. Routing tables can be created with the use of routing protocols, learned from network traffic, or may be provided by an administrator.

In general, 5G service-based architecture is designed in a way that all Network Functions are closely interconnected. These Network Functions may possess the ability to discover the peer nodes and transmit network information among the nodes. This approach is bound to create a spaghetti of inter connections between several user devices, such as laptop, smartphone, tablet, and the likes, connected through a network, which can hamper the flow of data between said user devices or may lead to loss of data. In certain scenarios, it may also lead to misplacement of data which is highly undesirable.

Conventional systems and methods are configured within a network that consists of several nodes, each having a distinct deployment scenario/architecture and functionality. Routing algorithms in the conventional systems and methods cannot manage distinct deployment scenario/architecture and functionality of each node. Hence establishment of communication channel between the nodes may get effected, which may, in turn, adversely affect flow of data in the network.

In addition, current systems and methods or routing techniques are unable to process a request related to transmission of data that corresponds to a node which is down/unavailable.

Hence, there is a need to provide a routing solution, which can optimise a data path of the information exchanged between user devices, and can resolve various network related issues as mentioned above.

### OBJECTS OF THE PRESENT DISCLOSURE

It is an object of the present disclosure to provide a 5G service based architecture that optimizes signalling controls.

It is an object of the present disclosure to enable a service provider to obtain better visibility into a core network.

It is an object of the present disclosure to provide a Service Communication Proxy (SCP) that enables message forwarding and routing to destination Network Function (NF)/NF service.

It is an object of the present disclosure to provide the SCF that enables communication security, load balancing, monitoring, and overload control.

It is an object of the present disclosure to request routing based on endpoint status where requests are divided proportionally between active endpoints.

It is an object of the present disclosure to provide a system and method that may enable error free data packet transfers.

It is an object of the present disclosure to provide a system and method that may enable the communication in an optimized way.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for performing ingress/egress active-active routing in a network. The system may include a controller in communication with an at least one public land mobile network (PLMN) cluster associated with a plurality of PLMN clusters. Each PLMN cluster may have a plurality of end points associated with the network. The controller may further include one or more processors coupled to a memory that stores instructions to be executed by the one or more processors. The controller may receive, from one or more source node devices in communication with the controller via the network, a plurality of requests to be transmitted to at least one PLMN cluster. The controller may determine status of each end point associated with the at least one PLMN cluster. The controller may route when the status of each end point associated with the at least one PLMN cluster is determined to be active, the plurality of requests through the at least one PLMN cluster for transmitting it to each endpoint. The plurality of requests may be routed equally to the plurality of endpoints associated with the at least one PLMN cluster based on a routing technique.

In an embodiment, the controller may be configured to route the plurality of requests until the status of the plurality of endpoints become inactive.

In an embodiment, the controller may be configured to determine a number of active endpoints at a predefined time.

In an embodiment, in case the status of the number of active endpoints are determined to be inactive, the controller may be configured distribute data traffic, pertaining to the plurality of requests in the network proportionally among the remaining number of active end points of said at least one PLMN cluster.

In an embodiment, in case the status of all the number of active endpoints is determined to be inactive, the controller may be configured to send a negative response to the at least one PLMN cluster.

In an embodiment, in case the status of all the number of active endpoints is determined to be inactive, the controller is further configured to stop routing of the plurality of requests to the said inactive endpoints.

In an embodiment, the routing technique may include at least one of a round robin technique, or a weighted scheduling technique.

In an embodiment, the controller may be configured to receive a plurality of responses from the plurality of endpoints, the plurality of responses are responses to the plurality of requests received by the plurality of endpoints.

In an embodiment, the controller may be configured to route the plurality of responses to the one or more source node devices in communication with the controller.

In an aspect, the present disclosure provides a method for performing ingress/egress active-active routing in a network. The method may include the step of receiving, by a controller, from one or more source node devices in communication with the controller via a network, a plurality of requests to be transmitted to at least one PLMN cluster associated with a plurality of PLMN clusters. The controller may be in communication with the at least one public land mobile network (PLMN) clusters, each PLMN cluster having a plurality of end points associated with the network. The controller may further include one or more processors coupled to a memory storing instructions executable by the one or more processors. The method may further include the step of determining by the controller, status of each end point associated with the at least one PLMN cluster. The method may include routing by the controller, when the status of each said end point associated with the at least one PLMN cluster is determined to be active, the plurality of requests through the at least one PLMN cluster for transmitting it to each said endpoint. The plurality of requests may be routed equally to the plurality of endpoints associated with the at least one PLMN cluster based on a routing technique.

In an embodiment, the method may include routing, by the controller, the plurality of requests until the status of the plurality of endpoints become inactive.

In an embodiment, the method may include determining, by the controller, a number of active endpoints at a predefined time.

In an embodiment, the method may include in case the status of the number of active endpoints is determined to be inactive, distributing, by the controller, data traffic, pertaining to the plurality of requests in the network proportionally among the remaining active end points of said at least one PLMN cluster.

In an embodiment, the routing technique may include at least one of a round robin technique, or a weighted scheduling technique.

In an embodiment, the method may include, in case the status of all the number of active endpoints is determined to be inactive, sending, by the controller, a negative response to the at least one PLMN cluster.

In an embodiment, the method may include in case the status of all the endpoints is determined to be inactive, stopping routing, by the controller, of the plurality of requests to the said inactive endpoints.

In an embodiment, the method may include receiving by the controller, a plurality of responses from the plurality of endpoints, the plurality of responses are responses to the plurality of requests received by the plurality of endpoints.

In an embodiment, the method may include routing by the controller, the plurality of responses to the one or more source node devices in communication with the controller.

In an aspect, the present disclosure provides a user equipment (UE) communicatively coupled with a controller. The UE may send a connection request to the controller. The UE may be operably coupled to the controller via a network. The UE may receive an acknowledgment of the connection request from the controller. The UE may transmit a plurality of signals in response to the connection request to the controller. The said controller may be in communication with at least one public land mobile network (PLMN) cluster associated with a plurality of PLMN clusters of a system. The controller may receive from one or more source node devices in communication with the controller via the network, a plurality of requests to be transmitted to the at least one PLMN cluster. The controller may determine status of each end point associated with the at least one PLMN cluster. The controller may route, when the status of each said end point associated with the at least one PLMN cluster is determined to be active, the plurality of requests through the at least one PLMN cluster for transmitting it to each said endpoint, wherein the plurality of requests are routed equally to a plurality of endpoints associated with the at least one PLMN cluster based on a routing technique.

In an aspect, a non-transitory computer readable medium (CRM) may include a processor with executable instructions to be executed by the processor. The processor may receive from one or more source node devices in communication with a controller via a network, a plurality of requests to be transmitted to at least one PLMN cluster. The processor may determine status of each end point associated with the at least one PLMN cluster. The processor may route when the status of each said end point associated with the at least one PLMN cluster is determined to be active, the plurality of requests through the at least one

PLMN cluster for transmitting it to each said endpoint. The plurality of requests may be routed equally to the plurality of endpoints associated with the at least one PLMN cluster based on a routing technique.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIGS. 1A-1B illustrates exemplary network architecture in which or with which a proposed system can be implemented, in accordance with an embodiment of the present disclosure.

FIG. 1C illustrates an exemplary representation of the network device 102 in accordance with an embodiment of the present disclosure.

FIG. 1D illustrates an exemplary method flow diagram, in accordance with an embodiment of the present disclosure.

FIG. 2 with reference to FIG. 1B, illustrates an exemplary diagram illustrating functioning of SCP, in accordance with an embodiment of the present disclosure.

FIG. 3A illustrates exemplary representation of flow diagram illustrating indirect communication, through the SCP, with delegated discovery, in accordance with embodiments of the present disclosure.

FIG. 3B illustrates exemplary representation of flow diagram illustrating indirect communication, through the SCP, without delegated discovery, in accordance with embodiments of the present disclosure.

FIG. 4 illustrates an exemplary representation of Service Communication Proxy (SCP) architecture, in accordance with an embodiment of the present disclosure.

FIG. 5 illustrates an exemplary overview of SCP deployment based on the 5G functionality where SCP is deployed in independent deployment units, in accordance with an embodiment of the present disclosure.

FIG. 6 illustrates an exemplary diagram representing deployment architecture

of active-active routing technique, in accordance with an embodiment of the present disclosure.

FIG. 7A illustrates functioning of the active-active routing mechanism when all endpoints in an active cluster are up, in accordance with an embodiment of the present disclosure.

FIG. 7B illustrates functioning of the active-active routing mechanism when some endpoints are up while some endpoints in the active cluster are down, in accordance with an embodiment of the present disclosure.

FIG. 8 illustrates an exemplary active-active routing mapping, in accordance with an embodiment of the present disclosure.

FIG. 9 illustrates an exemplary representation of Plmn-Id and Context Wise Table, in accordance with an embodiment of the present disclosure.

FIG. 10 illustrates an exemplary multiple routing policy, in accordance with an embodiment of the present disclosure.

FIG. 11 illustrates an exemplary computer system in which or with which embodiments of the present invention can be utilized in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

A Voice over Long-Term Evolution (VOLTE) solution places Session Initiation Protocol (SIP) application servers (e.g. CTAS) at the centre of a voice core network, managing connectivity between subscribers and implementation of supplementary services. Ro interface based online charging may be implemented in telecom network and CDRs generated by application servers, such as the CTAS, may be used by a mediation system for reconciliation purpose. With respect to CTAS deployment architecture, multiple CTAS clusters, having various CTAS instances, may be used to serve traffic of a single circle and each of the circles may have an assigned personal single CDL module. As the multiple CTAS instances are represented in the cluster, a need for determining Internet Protocol (IP) address of multiple CTAS instances for the circle is evaded as the CDL module may connect to the CTAS instances through an IP of their associated CTAS cluster thereby leading to effective utilization of network resources.

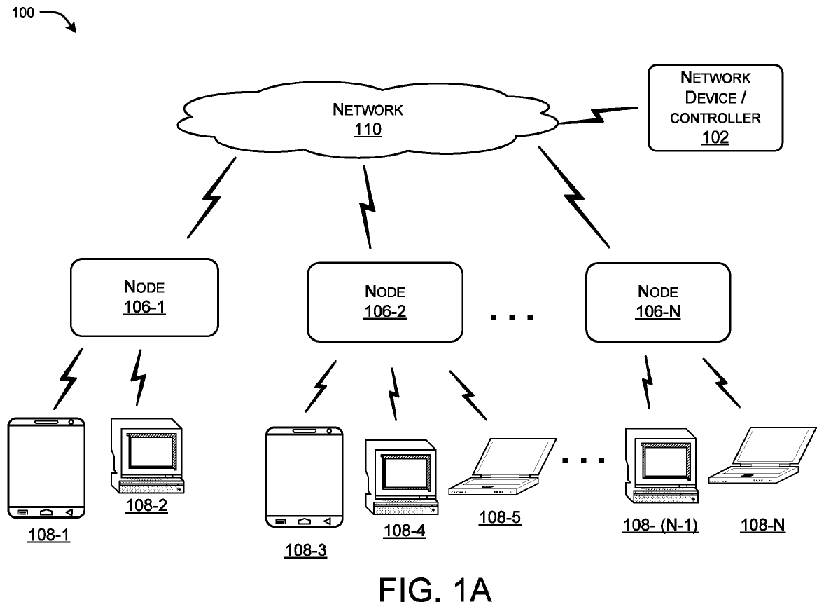

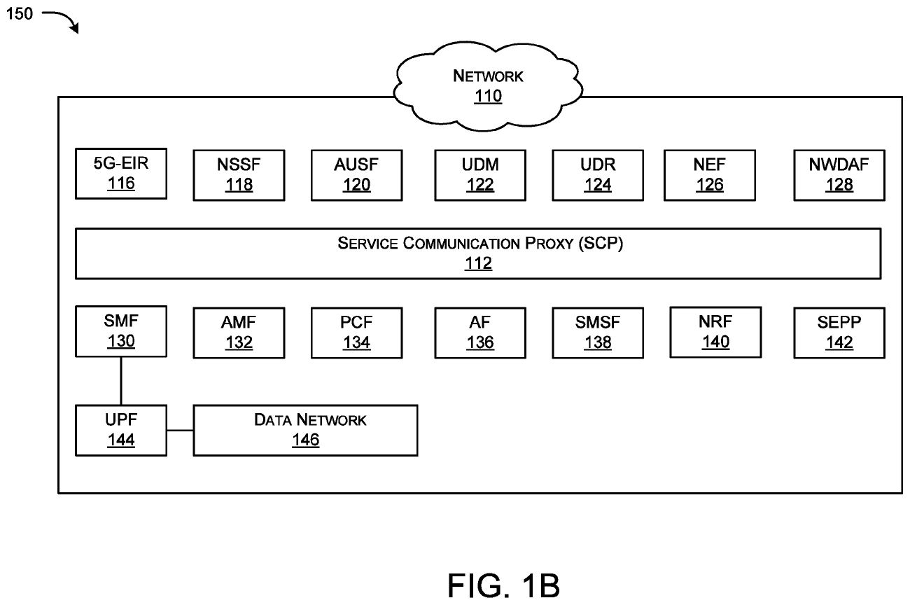

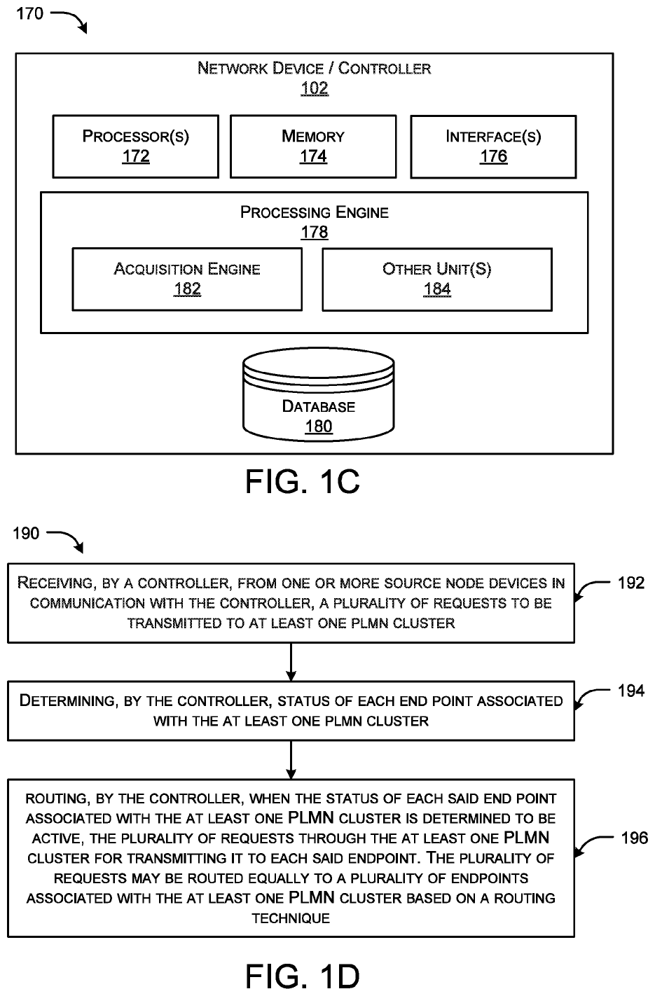

FIGS. 1A-1B illustrates exemplary network architecture 100, 150 in which or with which proposed system can be implemented, in accordance with an embodiment of the present disclosure.

In general, 5G service-based network architecture can be designed in a way that multiple nodes can be closely interconnected, and so could be corresponding network functions. In an embodiment, some of the network functions of the 5G network architecture are as follows:
Access and Mobility Management function (AMF): The AMF can receive all connection and session related information from a communication device (also referred to as User Equipment or UE, herein), and is responsible for handling connection and mobility management tasks. For instance, the AMF can aid in termination of NAS (Non-Access Stratum) signalling, NAS ciphering and integrity protection, and management tasks, such as, but not limited to, registration management, connection management, mobility management, access authentication and authorization, security context management.
Session Management function (SMF): The SMF may carry out functions related to session management, for example, session establishment, modification, and release. Further, the SMF can handle User Equipment (UE) IP address allocation and management, DHCP functions, termination of NAS signalling related to session management, DL data notification, traffic steering configuration for user plane function (UPF) for proper traffic routing, and the like.
User plane function (UPF): The UPF may connect actual data coming over corresponding Radio Area Network (RAN) to the Internet. In an exemplary embodiment, the UPF may carry out packet routing and forwarding, packet inspection, handles Quality of Service (QOS). Further, the UPF can acts as external PDU session point of interconnect to Data Network (DN), and also can act as an anchor point for intra-RAT mobility as well as inter-RAT mobility.
Policy Control Function (PCF): The PCF can provide unified policy framework, policy rules to CP functions, and access subscription information for policy decisions in UDR.
Authentication Server Function (AUSF): The AUSF can act as an authentication server, and function to check authenticity of information flowing through it.
Unified Data Management (UDM): The UDM can generate Authentication and Key Agreement (AKA) credentials, perform user identification handling, access authorization, and carry out subscription management.
Application Function (AF): The AF can check application influence on traffic routing, access NEF, and can interact with policy framework for policy control.
Network Exposure function (NEF): The NEF can carry out functions like exposure of capabilities and events, secure provision of information from external application to network, and translation of internal/external information.
NF Repository function (NRF): The NRF can perform service discovery function, maintains NF profile and check available NF instances.
Network Slice Selection Function (NSSF): The NSSF may aid in selecting of network slice instances to serve the UE, determining the allowed NSSAI, determining the AMF set to be used to serve the UE.

In an embodiment, the proposed architecture 100 can not only resolve the challenges introduced by the 5G service-based architecture but can also optimize signalling controls. The presented architecture 100 can enable a service provider to get a better visibility into core network, where the core network can be defined as backbone of any network architecture, for example 5G service-based architecture, and may be configured to interconnect distinct networks associated with the architecture. Therefore, the core network can provide a path for exchange of information between one or more networks, and corresponding sub networks. Further, as a backbone, the core network can tie together diverse networks, say LAN, WAN, MAN, etc. which can be present within the same building, in different buildings, in a campus environment, or remotely located over wide areas.

The proposed architecture 100 may also boost the network performance by continuously coordinating with other network functions. According to an embodiment, the 5G system architecture may leverage service-based interactions directly between NF Service consumers and NF Service producers, or indirectly via an SCP (Service Communication Proxy).

As illustrated in FIG. 1A, the presented architecture 100 can include a network device 102 which may be coupled with a plurality of nodes including Node 106-1, Node 106-2 . . . . Node 106-N, and configured to facilitate a secured communication among the plurality of nodes (collectively referred to as nodes 106, and individually referred to as node 106, hereinafter). The network device 102 may be referred to as the controller 102 and more specifically a SCP controller herein.

In an embodiment, each of the nodes can be configured to be coupled with a multitude of user devices 108-1, 108-2, 108-3, 108-4 . . . 108-(N-1), 108-N (collectively referred to as user devices 108, and individually referred to as user device 108, hereinafter).

In one embodiment, the presented architecture 100 can facilitate to establish a secured communication between user devices associated with distinct nodes. In another embodiment, the presented architecture 100 can facilitate to establish a secured communication between user devices associated with the same node.

The user device 108 may be at least one of a wired device or wireless device. For example, the wired device may be a landline phone, a terminal device, or any other stationary device through which communication may be established. The wireless device may be a mobile device that may include, for example, a cellular telephone, such as a feature phone or smartphone and other devices. The user device 108 may not be limited to the above-mentioned devices, but may include any type of device capable of wired or wireless communication, such as a cellular phone, a tablet computer, a Personal Digital Assistant (PDA), a Personal Computer (PC), a laptop computer, a media center, a work station, and other such devices. In an embodiment, the user device 108 may be at least one of the wireless or wireline devices that may be subscribed or registered to the network service provided by the service provider.

In an embodiment, the user device 108 may include a user equipment (UE) communicatively coupled to the controller 102. The coupling may include the steps of receiving a connection request from the controller 102, sending an acknowledgment of connection request to the controller and further transmitting a plurality of signals in response to the connection request.

In an exemplary embodiment, the architecture 100 can effectively establish a secured communication between user device 108-1 and user device 108-2, where the user device 108-1 and the user device 108-2 both are coupled with Node 106-1. In another exemplary embodiment, the architecture 100 can facilitate to establish a secured communication between user device 108-2 and user device 108-N with equal effectiveness, where the user device 108-2 is coupled with Node 106-1 and the user device 108-N is coupled with Node 106-N.

In an exemplary embodiment, the network device 102 may be configured as an application server and may be communicably operational or may be integrated with a user device 108 via a network 110 coupled with a server 104. In another exemplary embodiment, the user device 108 may a wireless device. The wireless device may be a mobile device that may include, for example, cellular telephone, such as a feature phone or smartphone and other devices. The user device 108 may not be limited to the above-mentioned devices, but may include any type of device capable of providing wireless communication, such as a cellular phone, a tablet computer, a personal digital assistant (PDA), a personal computer (PC), a laptop computer, a media centre, a work station and other such devices.

In one embodiment, the network 110 may be a 5G network that may include at least one of a wireless network, a wired network or a combination thereof. The network 100 may act as a core network and may have a plurality of nodes, end-points and/or proxies. The network 110 may be implemented as one of the different types of networks, such as Intranet, Local Area Network (LAN), Wide Area Network (WAN), Internet, and the like. Further, the network 110 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), Automatic repeat request (ARQ), and the like. In an embodiment, the core network may include and implement a Service Communication Proxy (SCP) 112, Network functions (NF) and proxies for the NFs.

In an embodiment, the network 110 may pertain to a 5G network that may be facilitated through, for example, Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a WIFI or other LAN access network, or a satellite or terrestrial wide-area access network such as a wireless microwave access (WIMAX) network. In an example embodiment, the communication network may enable 5G network based on subscription pertaining to the user/user device and/or through a Subscriber Identity Module (SIM) card. Various other types of communication network or service may be possible.

In an example, the network 110 may utilize different sort of air interface, such as a code division multiple access (CDMA), time division multiple access (TDMA), or frequency division multiple access (FDMA) air interface and other implementation. In an example embodiment, the wire-line user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

In an embodiment, the wireless device may be outside of the core network and may request for a particular service. The request may be communicated with an (ingress) node or edge node of the core network and may be routed to multiple additional nodes until the request reaches its destination which is a provider.

In an embodiment, as illustrated in FIG. 1B, the presented architecture 100 as illustrated in FIG. 1A may facilitate interaction of the SCP 112 along with various distinct network components and corresponding network functions. The SCP 112 may act as a decentralized solution and may comprise of a control plane and a data plane. Further, the SCP 112 may be deployed along side of 5G NF for providing routing control, resiliency, and observability to a core network 114.

In one embodiment, within the core network 114 (that is a component of the network 110) the SCP 112 may be communicatively coupled with 5G-EIR 116. The 5G-EIR may be defined as an independent network component that may help telecom operators in protecting their networks. The 5G-EIR may aid in protecting a network by providing a mechanism to restrict malicious user terminals in the network.

In other embodiment, the SCP 112 may be communicatively coupled to a network component supporting Network Slice Selection Function (NSSF) 118. The NSSF 118 may select network slice instances to serve user device 108, determine allowed NSSAI and determine AMF set that is used to serve the user device 108.

In another embodiment, the SCP 112 may be communicatively coupled with a network component supporting Authentication Server Function (AUSF) 120. The AUSF may act as an authentication server, and may function to check authenticity of information flowing through it.

In yet another embodiment, the SCP 112 may be communicatively coupled with network components supporting Unified Data Management (UDM) 122 and Unified Data Repository (UDR) 124. The UDM 122 may facilitate providing a centralized technique to control network user data. For instance, the UDM 122 may generate Authentication and Key Agreement (AKA) credentials, perform user identification handling, access authorization and carry out subscription management.

Further, the UDR 124 may act as a converged repository for information related to subscribers and can facilitate providing service to a number of network functions. For example, the 5G UDM 122 may use the UDR 124 to store and retrieve data pertaining to subscription. Alternatively, Policy Control Function (PCF) may use the UDR to store and retrieve policy related data. Further, Network Exposure Function (NEF) 126 may also use the UDR 124 to store subscriber related data that is permitted to be exposed to a third party application(s).

In one embodiment, the SCP 112 may be coupled with a network component supporting the NEF 126. The NEF 126 may carry out functions like exposure of capabilities and events, secure provision of information from external application to network and translation of internal/external information.

In yet another embodiment, the SCP 112 may be coupled with a network component supporting a 5G network data analytics function (NWDAF) 128. The NWDAF 128 may be configured to streamline and control the way core network data is produced and consumed and provide insights and suggest actions to be taken in order to enhance end-user experience. In an exemplary embodiment, the NWDAF 128 may be configured to overcome market fragmentation and proprietary solutions in an area of network analytics. Further, the NWDAF 128 may address three primary standardization points—
Data collection interface from network nodes
Predefined analytics insights
Data exposure interface for consumers

In an embodiment, the SCP 112 may be coupled with network components supporting Session Management function (SMF) 130, Access and Mobility Management function (AMF) 132, Policy Control Function (PCF) 134, and Application Function (AF) 136. The SMF 130 may carry out functions related to session management, for example, session establishment, modification, and release. Further, the SMF 130 may handle User Equipment (UEs), IP address allocation and management, DHCP functions, termination of NAS signalling related to session management, DL data notification, traffic steering configuration for user plane function (UPF) for proper traffic routing, and the like.

Further, the AMF 132 may receive all connection and session related information from a communication device (also referred to as User Equipment (UE) 108, herein), and may be responsible for handling connection and mobility management tasks.

Furthermore, the PCF 134 may provide unified policy framework, policy rules to CP functions, access subscription information for policy decisions in the UDR 124. The AF 136 may check application influence on traffic routing, access NEF, and may interact with policy framework for policy control.

In an embodiment, the SCP 112 may be communicatively coupled with network components that support, for example, Short Message Service Function (SMSF) 138, NF Repository function (NRF) 140, Security Edge Protection Proxy (SEPP) 142, and User plane function (UPF) 144. The SMSF 138 may facilitate the transfer of SMS over NAS, in the 5G architecture. Moreover, the SMSF 138 may conduct subscription checking as well as may perform a relay function between the user device 108 and the Short Message Service Centre (SMSC) through interaction with the AMF 132.

Further, the NRF 140 may be configured to perform service discovery function, maintain NF profile and may also check available NF instances. Also, Security Edge Protection Proxy (SEPP) 142 may facilitate a secured communication between one or more 5G networks. The SEPP 142 may also provide end-to-end confidentiality and/or integrity between source and destination network for all 5G interconnect roaming messages.

Furthermore, the UPF 144 may function to connect actual data coming over corresponding Radio Area Network (RAN) to the Internet. In an exemplary embodiment, the UPF 144 may carry out packet routing and forwarding, packet inspection, and handle Quality of Service (QOS). Further, the UPF 144 may act as an external PDU session point of interconnect to Data Network (DN), and also may act as an anchor point for intra-RAT mobility as well as inter-RAT mobility.

It should be noted that functioning of the SCP 112 may be independent of distance between the NF. Moreover, the SCP 112 may facilitate providing peer-to-peer communication between peer instances/nodes. Further, the SCP 112 may provide end-to-end connectivity between different nodes having distinct deployment scenarios, architecture, and functionality while managing the architectures efficiently.

In an embodiment, the SCP 112 may be a component of the core network 110 and may manage the routing and various other aspects for the received requests including, for example, mapping AR-DR, and configuring DR to act as AR and the like.

In an embodiment, the controller 102 may be in communication with an at least one node 106 which may be a public land mobile network (PLMN) cluster. Each PLMN cluster may have a plurality of end points associated with the network 110. For example, the endpoints can include a plurality of user devices 108. The controller 102 may further include one or more processors coupled to a memory storing instructions executable by the one or more processors. The controller 102 may be configured to receive, from one or more source node devices 106 in communication with the controller 102, a plurality of requests to be transmitted to at least one PLMN cluster. Further, the controller 102 may determine status of each end point associated with the at least one PLMN cluster. The controller 102 may route, when the status of each said end point associated with the at least one PLMN cluster is determined to be active, the plurality of requests through the at least one PLMN cluster for transmitting it to each said endpoint. The plurality of requests may be routed equally to a plurality of endpoints associated with the at least one PLMN cluster based on a routing technique.

In an embodiment, the controller 102 may be configured to use a weighted scheduling technique to equally route the plurality of endpoints associated with the at least one PLMN cluster based on the plurality of requests received from the one or more source node devices 106.

In an embodiment, the controller 102 may be configured to use a round robin technique to equally route the plurality of endpoints associated with the at least one PLMN cluster based on the plurality of requests received from the one or more source node devices 106.

In an embodiment, the controller 102 may be further configured to route the plurality of requests until the status of the plurality of endpoints become inactive and also determine a number of active endpoints at a predefined time.

In an embodiment, in case the status of the number of active endpoints are determined to be inactive, the controller 102 may be configured to distribute data traffic, pertaining to the plurality of requests in the network 110 proportionally among the remaining number of active end points of said at least one PLMN cluster. In case the status of all the number of active endpoints are determined to be inactive, the controller 102 may send a negative response to the at least one PLMN cluster. On the other hand, in case the status of all the number of active endpoints are determined to be inactive, the controller may stop routing of the plurality of requests to the inactive endpoints.

In an embodiment, the controller 102 may be further configured to receive a plurality of responses from the plurality of endpoints, the plurality of responses being responses to the plurality of requests received by the plurality of endpoints. The controller may further route the plurality of responses to the one or more source node devices 106 in communication with the controller 102.

FIG. 1C illustrates an exemplary representation 170 of the network device 102 in accordance with an embodiment of the present disclosure. In an aspect, the controller 102 may comprise one or more processor(s) 172. The one or more processor(s) 172 may be implemented as one or more microprocessors, microcomputers, microcontrollers, digital signal processors, central processing units, logic circuitries, and/or any devices that process data based on operational instructions. Among other capabilities, the one or more processor(s) 172 may be configured to fetch and execute computer-readable instructions stored in a memory 174 of the controller 102. The memory 174 may be configured to store one or more computer-readable instructions or routines in a non-transitory computer readable storage medium, which may be fetched and executed to create or share data packets over a network service. The memory 174 may comprise any non-transitory storage device including, for example, volatile memory such as RAM, or non-volatile memory such as EPROM, flash memory, and the like.

In an embodiment, the controller 102 or the network device 102 may include an interface(s) 176. The interface(s) 176 may comprise a variety of interfaces, for example, interfaces for data input and output devices, referred to as I/O devices, storage devices, and the like. The interface(s) 176 may facilitate communication of the controller 102. The interface(s) 176 may also provide a communication pathway for one or more components of the system 100. Examples of such components include, but are not limited to, processing engine(s) 178 and a database 180.

The processing engine(s) 178 may be implemented as a combination of hardware and programming (for example, programmable instructions) to implement one or more functionalities of the processing engine(s) 178. In examples described herein, such combinations of hardware and programming may be implemented in several different ways. For example, the programming for the processing engine(s) 178 may be processor executable instructions stored on a non-transitory machine-readable storage medium and the hardware for the processing engine(s) 178 may comprise a processing resource (for example, one or more processors), to execute such instructions. In the present examples, the machine-readable storage medium may store instructions that, when executed by the processing resource, implement the processing engine(s) 178. In such examples, the controller 102 may comprise the machine-readable storage medium storing the instructions and the processing resource to execute the instructions, or the machine-readable storage medium may be separate but accessible to the system 100 and the processing resource. In other examples, the processing engine(s) 178 may be implemented by electronic circuitry.

The processing engine 178 may include one or more engines selected from any of a data acquisition engine 182, and other engines 184.

FIG. 1D illustrates an exemplary method flow diagram 190, in accordance with an embodiment of the present disclosure. The method 190 may include at 192, the step of receiving, by a controller 102, from one or more source node devices 106 in communication with the controller 102, a plurality of requests to be transmitted to at least one PLMN cluster associated with a plurality of PLMN clusters. The controller 102 may be in communication with the plurality of PLMN clusters.

The method 190 may also include at 194, the step of determining, by the controller 102, status of each end point associated with the at least one PLMN cluster. The controller may determine if the status of each point is active or inactive.

Furthermore, the method may include at 196, the step of routing, by the controller 102, when the status of each said end point associated with the at least one PLMN cluster is determined to be active, the plurality of requests through the at least one PLMN cluster for transmitting it to each said endpoint. The plurality of requests may be routed equally to a plurality of endpoints associated with the at least one PLMN cluster based on a routing technique.

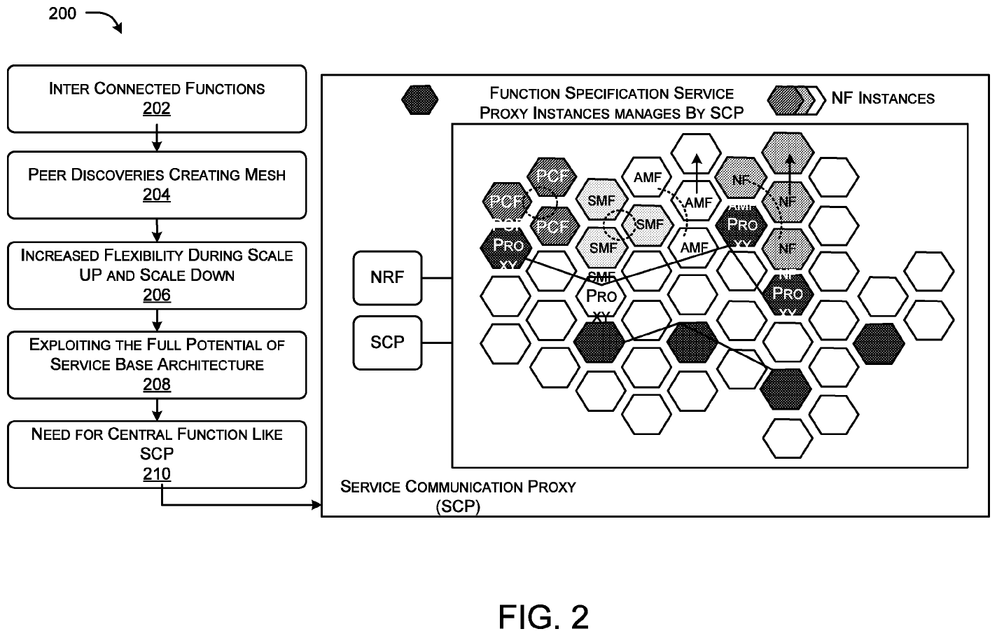

FIG. 2 with reference to FIG. 1B, illustrates an exemplary diagram 200 illustrating functioning of the SCP 112. The SCP 112 may not only resolve the challenges related to the 5G service based architecture but may also optimize signalling controls, and thus may provide better visibility into the core network. The SCP 112 may also boost network performance by continuously coordinating with other network functions.

In an embodiment, the proposed SCP 112 may be configured to intelligently carry out load balancing, routing, monitoring, and congestion control at an application layer, i.e., Layer 7 of an Open System Interconnect (OSI) model. In one embodiment, the SCP 112 can carry out, at block 202, interconnected functions, and facilitate communication, at block 204, in between peer nodes and create a mesh based on discoveries/information delivered by the peer nodes.

Further, the SCP 112 may facilitate, at block 206, to scale up and scale down functions and that too with increased flexibility. Furthermore, the SCP 112 may enable, at block 208, exploitation of maximum potential of service-based architecture. Moreover, at block 210, the SCP 112 may address the need for a module with some central function, and thereby may facilitate a secured communication of the nodes 106 with the SCP 112. The SCP 112 may be configured to control flow of data/information between the nodes by facilitating load balancing, routing, traffic monitoring, congestion control, and service discovery in the Layer 7 service mesh.

In another exemplary embodiment, the SCP 112 may determine Network Function (NF) instances, and correspondingly the SCP 112 may manage function specification service proxy instances. In another exemplary embodiment, the NRF 140 may provide facilities of registration, re-registration and NF discovery along with.

In another exemplary embodiment, the SCP 112 may include NF instances which may communicate with NRF 140 through a SCP controller. For instance, a PCF proxy running with ‘x’ NF services and ‘y’ instances may communicate, through the SCP controller, with the NRF 140, which may act as central repository and may include information about all the NFs.

In another exemplary embodiment, the SCP controller may be trained to configure SCP proxies based on real-time situation. Therefore, no pre-configuration of the SCP proxies may be required.

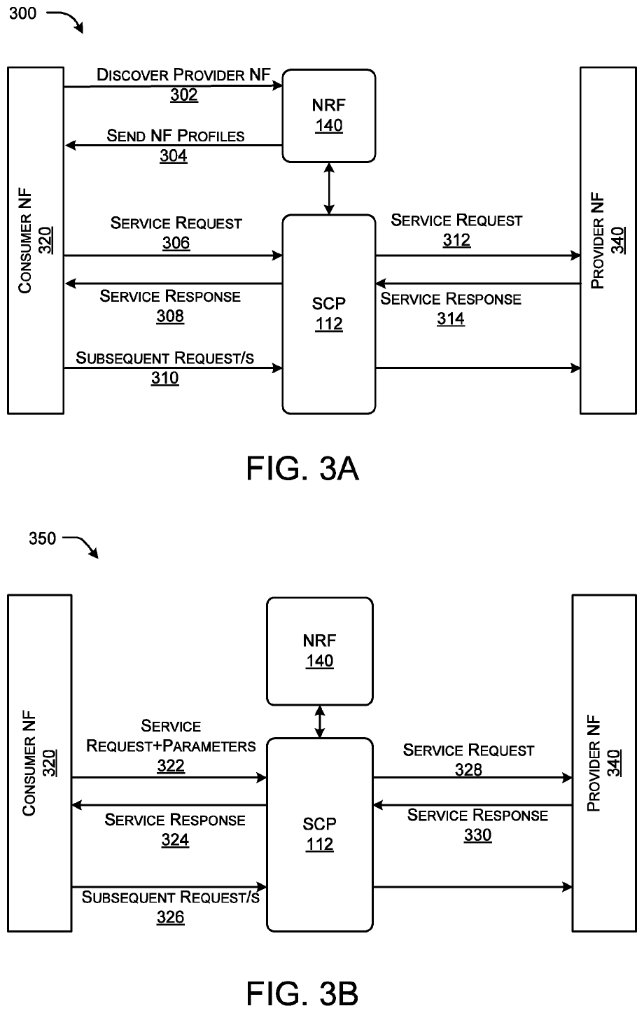

Referring to FIGS. 3A and 3B, the SCP 112 may support both the scenarios of indirect communication, i.e. indirect communication with/without delegated discovery, for discovery of the peer network functions.
Indirect communication without delegated discovery: This mode of communication may consider input of users when they perform discovery. through their user devices 108, by querying the NRF. Based on discovery result, the consumer may select an NF instance of NF Service instance set. The consumer may send the request to the SCP containing the address of the selected service producer pointing to an NF service instance or a set of NF service instances. In the latter case, the SCP may select an NF service instance. If possible, the SCP may interact with NRF to get selection parameters such as location, capacity, and the like. Further, the SCP may route the request to the selected NF service producer instance.
Indirect communication with delegated discovery: This mode of communication functions even when users do not perform any discovery or selection. In an instance, when consumer adds any necessary discovery and selection parameters required to find a suitable producer to the service request. The SCP uses the request address and the discovery selection parameters in the request message to route the request to a suitable producer instance. The SCP may perform discovery with an NRF and obtain the discovery result.

In an exemplary embodiment, as illustrated in FIG. 3A, 300, during indirect communication without delegated discovery mode, the system may discover, at 302, NF of a provider, and then the NRF 140 may send, at 304, corresponding NF profiles to the consumer NF 320. Further, a service request may be transmitted, at 306, from the consumer NF 320 to the SCP 112, which may further be fed, at 312, to provider NF 340. The provider NF 340 may, in turn, generate, at 314, a service response, which may further be transmitted, at 316, to the consumer NF 320 through the SCP 112. Similarly, subsequent request(s) may be transmitted, at 310, which may be further processed in the same manner.

In an exemplary embodiment, as illustrated in FIG. 3B, 350, during Indirect communication with delegated discovery mode, a service request, including parameters, may be transmitted, at 322, from the consumer NF 320 to the SCP 112, which may further be fed, at 328, to the provider NF 340. The provider NF 340 may, in turn, generate, at 330, a service response, which may further be transmitted, at 324, to the consumer NF 320 through the SCP 112. Similarly, subsequent request(s) may be transmitted, at 326, which may be further processed in the same manner.

In an exemplary embodiment, the proposed SCP may also be used for indirect communication between NFs and NF services within any or a combination of Visiting (VPLMN) and Home PLMN (HPLMN).

According to an embodiment, apart from acting as a proxy or a routing agent between various Network Functions, the SCP 112 may also be configured to carry out following functionalities:
Communication Security: The SCP platform may be configured to allow only authorised consumer NFs to communicate with the provider NF.
Load balancing: The provider NFs may configure various load balancing techniques such as Round Robin and Weighted Scheduling, wherein in the Round Robin load balancing technique, client requests may be routed to available servers on a cyclical basis. Round robin server load balancing may work at its best when servers have roughly identical computing capabilities and storage capacity.
Security Supporting: The SCP also supports security mechanisms between the consumers and providers of the network services.
Traffic Monitoring: The SCP may monitor the performance of the Provider NFs in terms of number of service requests being processed.
Traffic Prioritization: The SCP platform may be configured to give priorities to specific Consumer NFs requests against any other Consumer NFs.
Discovery of NFs: SCP provides interfaces to identify most appropriate instances of other network functions (e.g. AUSF, PCF) for a specific UE's SUPI, SUCI or GPSI.
Overload control: The SCP has capability to put a cap on number of authorisation on a specific instance of Provider NFs. This means, in case where number of Consumer Application reaches to a threshold limit, it will not authorise new consumer NFs.

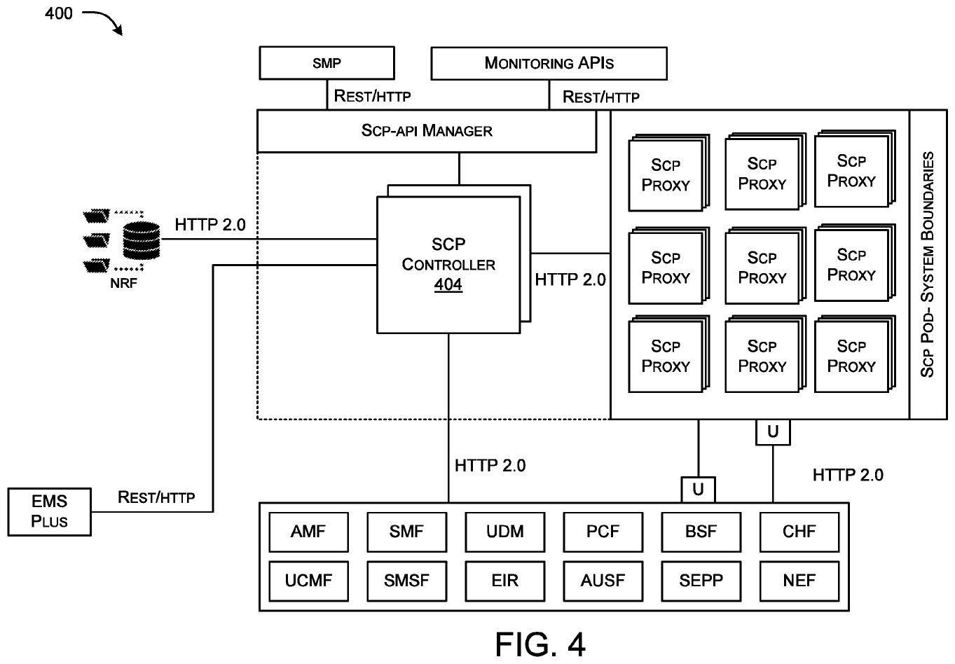

Referring to FIG. 4, 400, a Point-Of-Delivery (POD) is displayed as outlined by dashed lines and alongside are shown boundaries related to the SCP 112.

In an embodiment, the SCP architecture may include the following functionalities—
Indirect Communication
Delegated Discovery
Message forwarding and routing to destination NF/NF service
Communication security (e.g. authorization of the NF Service Consumer to access the NF Service Producer API), load balancing, monitoring, overload control, etc.
Optionally interact with UDR, to resolve the UDM Group ID/UDR Group ID/AUSF Group ID/PCF Group ID/CHF Group ID/HSS Group ID based on UE identity, e.g. SUPI or IMPI/IMPU.

In an embodiment, the proposed SCP architecture may include a SCP Proxy 402 along with a SCP controller 404. In another embodiment, the SCP Proxy 402 may either include:
Ingress Proxy: This proxy instance ensures incoming traffic for producer NF based on configured policy default is round robin.
Egress Proxy: This proxy instance ensures consumer's outgoing traffic flow to a right SCP Ingress proxy, and routing based on NF or SCP selection criteria.
   It should be noted that SCP's Hybrid deployment is also possible where a single SCP Instance can act as egress as well as ingress proxy.

In an embodiment, the SCP architecture may include multiple SCP proxies 402-1, 402-2, 402-3 . . . 402-N, which may be communicatively linked to the SCP controller 404 along with NRF, EMS Plus, SMP, APIs, and various network functions via an HTTP module.

Further, the SCP controller 404 may be configured to manage all SCP proxy instances and select appropriate proxy instance as egress or ingress for target NFs during NF registration and discovery flow. Furthermore, in order to do so the SCP Controller 404 may need to be deployed in front of NRF clusters serving for multiple PLMN or Single PLMN.

In an exemplary embodiment, the SCP controller 404 may configure some instances of PLMN to act as a Disaster Recovery (DR) cluster for corresponding set of Active PLMN cluster. In one embodiment, the DR cluster may even act as an active cluster in response to a request.

In one exemplary embodiment, a single DR cluster may be assigned or mapped for more than one active cluster. In another exemplary embodiment, more than one DR clusters may be assigned or mapped to a single active cluster.

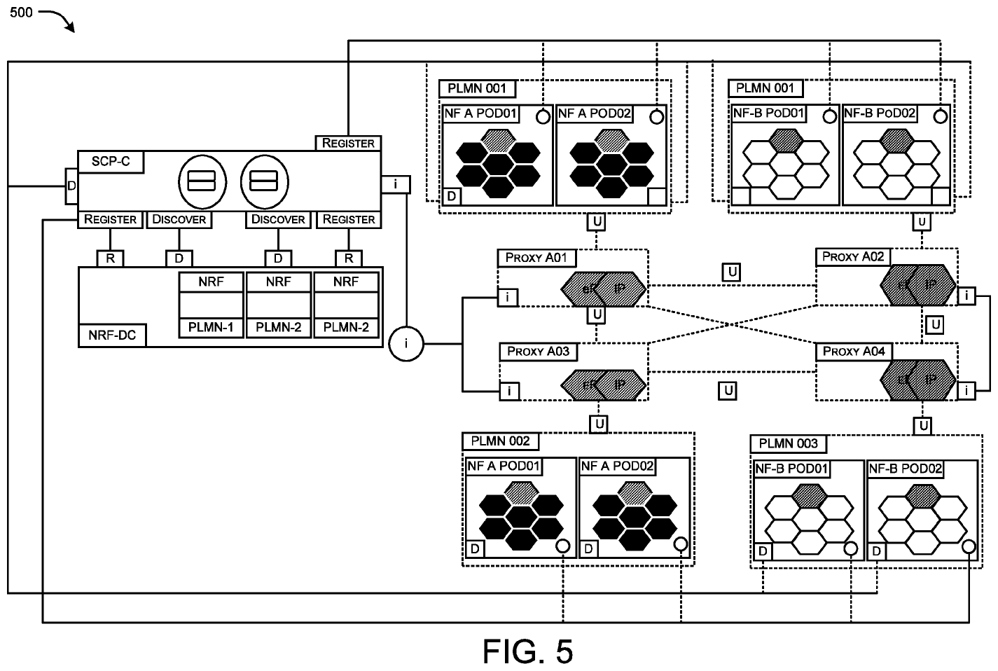

Referring to FIG. 5, an exemplary overview 500 of SCP deployment based on the 5G functionality where SCP is deployed in independent deployment units is illustrated, in accordance with an embodiment of the present disclosure.

The SCP deployment may be designed in a way to support:
One SCP proxy instance for Single NF Type considered for one PLMN.
One SCP Proxy instance for Multiple NF Type considered for One PLMN.

One SCP Proxy instance for Multiple NF Type considered for multiple PLMN.
Multiple Proxies in Single PLMN for Multiple NF Types
Single SCP Controller for Multiple NRF instances considered for Multiple PLMN.

In an embodiment, the SCP may be configured to provide different types of routing techniques for an SCP Proxy. The routing techniques may be implemented as per specific requirements of different NF Teams and their GR/DR handling.

### EXEMPLARY SCENARIO

In an embodiment, an egress-active-active routing mechanism is presented.

The egress-active-active routing mechanism may be used at Egress SCP Proxy. The egress-active-active routing mechanism is a simple round robin between active endpoints without having any requirement of GR/DR cluster. The SCP may route request until and unless all the configured endpoints go down. By way of an example, suppose there is one cluster “Cluster A” having four endpoints in its cluster Endpoint1, Endpoint2, Endpoint3 and Endpoint4. Here routing request may be routed equally on the endpoints Endpoint1, Endpoint2, Endpoint3 and Endpoint4 i.e., at rate of 25% each.

In an embodiment, an ingress-active-active routing mechanism is presented. The ingress-active-active routing mechanism may be used at Ingress SCP Proxy. The ingress-active-active routing mechanism is similar to the egress-active-active routing policy and is a simple round robin between active endpoints without having any requirement of GR/DR cluster. The SCP may route request until and unless all the configured endpoints go down. By way of an example, suppose there is one cluster “Cluster A” having four endpoints in its cluster Endpoint1, Endpoint2, Endpoint3 and Endpoint4. Here routing request may be routed equally on the endpoints Endpoint1, Endpoint2, Endpoint3 and Endpoint4 i.e., at rate of 25% each.

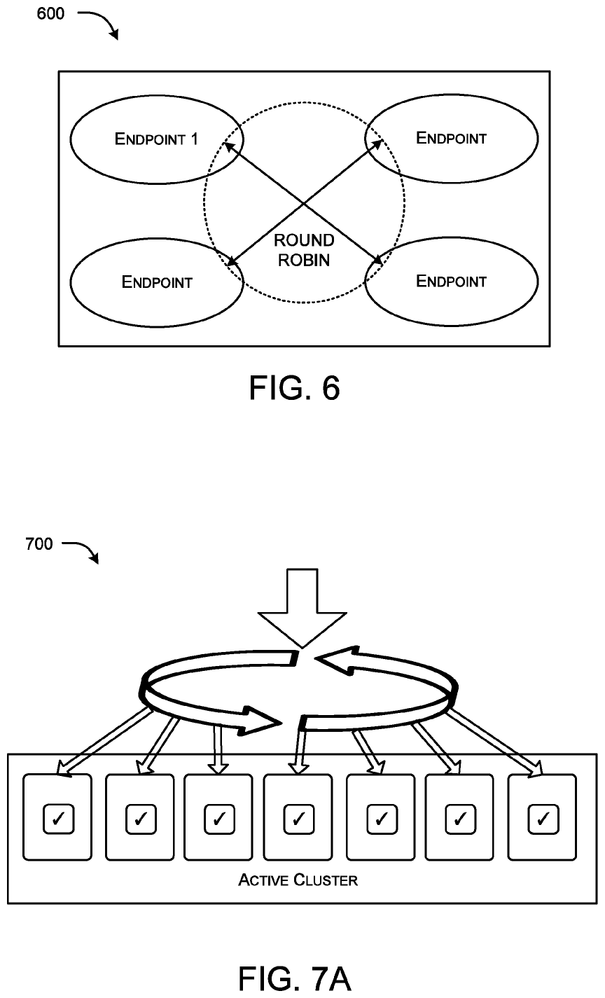

With respect to FIG. 6 exemplary diagram 600 representing deployment architecture of active-active routing technique is illustrated, in accordance with an embodiment of the present disclosure. In an embodiment, a request for routing based on endpoint status may be obtained. The requests may be divided proportionally between the active endpoints. In case any endpoint goes down then its share of traffic may be divided between the active endpoints. When all the endpoints are down then negative response may be given. The generated response may remain similar both in case of the egress-active-active routing mechanism and the ingress-active-active routing mechanism.

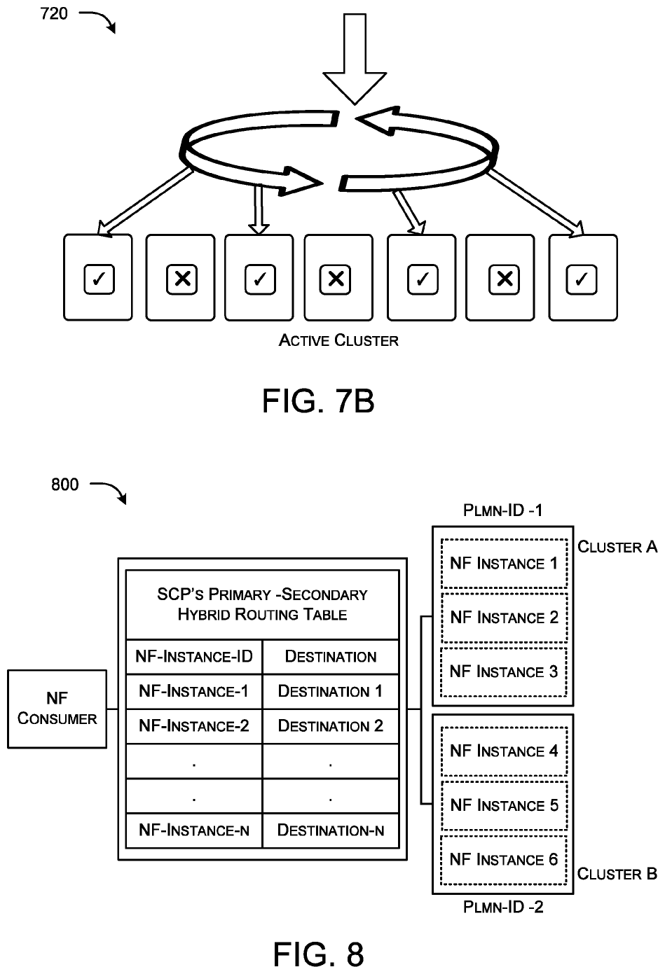

FIG. 7A illustrates functioning 700 of the active-active routing mechanism when all endpoints in an active cluster are up, in accordance with an embodiment of the present disclosure. A request to route traffic may be obtained, and then, it may be evaluated to determine whether any/at least one endpoint is active. If all the end points are found to be active, then the traffic may be equally divided amongst the nodes present within the active cluster.

FIG. 7B illustrates functioning 720 of the active-active routing mechanism when some endpoints are up while some endpoints in the active cluster are down, in accordance with an embodiment of the present disclosure. When a request to route traffic is obtained, and then, it may be evaluated to determine whether any/at least one endpoint is active. If some of the end points are found to be active, while others are found to be not active, then the traffic may be equally divided amongst the active nodes present within the active cluster.

As may be appreciated, the routing mechanism as discussed in FIG. 7A and FIG. 7B may hold for both the egress-active-active routing mechanism and the ingress-active-active routing mechanism.

FIG. 8 illustrates an exemplary 800 active-active routing mapping, in accordance with an embodiment of the present disclosure. With respect to FIG. 8, a NF consumer may have a SCP active-active routing table. In addition, NF instances with respect to the routing table may be maintained.

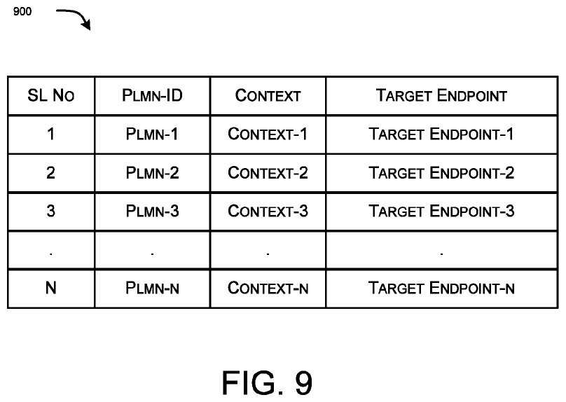

FIG. 9 illustrates an exemplary 900, Plmn-Id and Context Wise Table, in accordance with an embodiment of the present disclosure. As illustrated in FIG. 9A, a Plmn-Id with a corresponding Context and a Target Endpoint is represented.

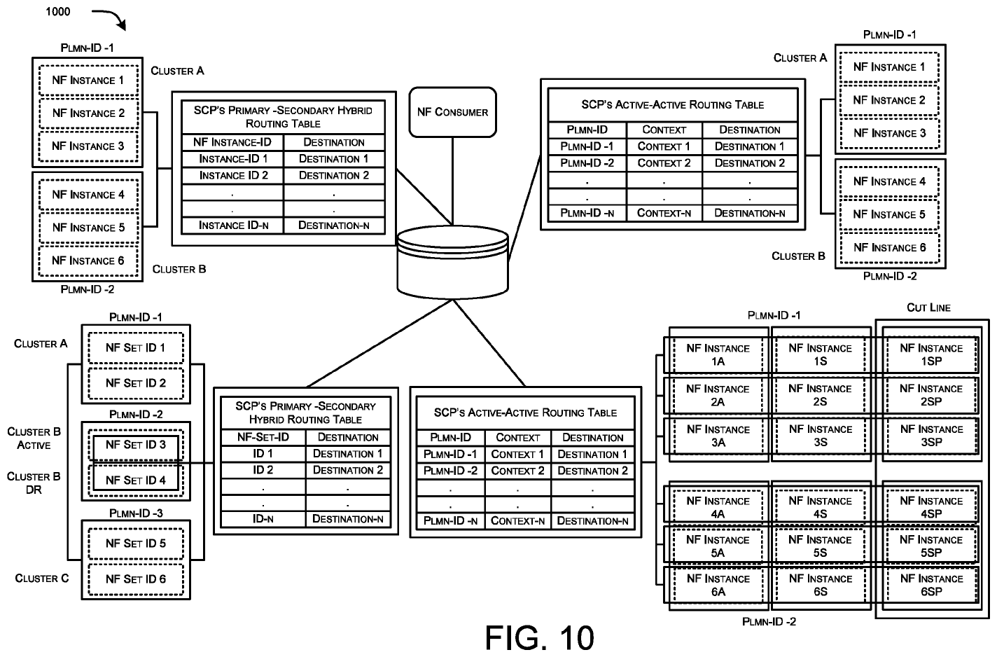

FIG. 10 illustrates an exemplary 1000, multiple routing policy, in accordance with an embodiment of the present disclosure. With respect to FIG. 10, a NF consumer may be connected to a router and the router may maintain multiple SCPs routing tables. The routing tables may maintain information for each of the connected clusters.

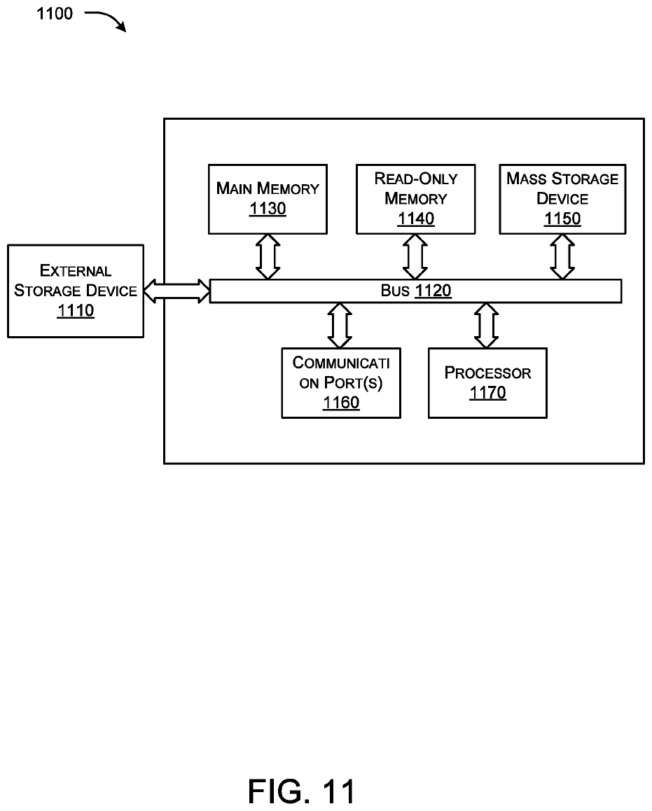

FIG. 11 illustrates an exemplary computer system 1100 in which or with which embodiments of the present invention can be utilized in accordance with embodiments of the present disclosure. As shown in FIG. 11, computer system 1100 can include an external storage device 1110, a bus 1120, a main memory 1130, a read only memory 1140, a mass storage device 1170, communication port 1160, and a processor 1170. A person skilled in the art will appreciate that the computer system may include more than one processor and communication ports. Processor 1170 may include various modules associated with embodiments of the present invention. Communication port (1180 can be any of an RS-232 port for use with a modem based dialup connection, a 10/100 Ethernet port, a Gigabit or 10 Gigabit port using copper or fiber, a serial port, a parallel port, or other existing or future ports. Communication port (1180 may be chosen depending on a network, or any network to which computer system connects. Memory 1130 can be Random Access Memory (RAM), or any other dynamic storage device commonly known in the art. Mass storage 1150 may be any current or future mass storage solution, which can be used to store information and/or instructions.

Bus 1120 communicatively couples processor(s) 1170 with the other memory, storage and communication blocks. Optionally, operator and administrative interfaces, e.g. a display, keyboard, joystick and a cursor control device, may also be coupled to bus 1120 to support direct operator interaction with a computer system. Other operator and administrative interfaces can be provided through network connections connected through communication port 1160. Components described above are meant only to exemplify various possibilities. In no way should the aforementioned exemplary computer system limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides a 5G service based architecture that optimizes signalling controls.

The present disclosure utilizes a service provider to obtain better visibility into a core network.

The present disclosure provides a Service Communication Proxy (SCP) that enables message forwarding and routing to destination Network Function (NF)/NF service.

The present disclosure provides the SCF that enables communication security, load balancing, monitoring, and overload control.

The present disclosure provides a system that enables request routing based on endpoint status where requests are divided proportionally between active endpoints.

The present disclosure provides a system and method that may enable error free data packet transfers.

The present disclosure provides a system and method that may enable the communication in an optimized way.

We claim:

1. A system (100) for performing ingress/egress active-active routing in a network (110), the system (100) comprising:
a controller (102) in communication with an at least one public land mobile network (PLMN) cluster associated with a plurality of PLMN clusters, wherein the at least one PLMN cluster has a plurality of end points associated with the network (110), the controller (102) comprising one or more processors (172) coupled to a memory (174) storing instructions executable by the one or more processors (172), the controller (102) configured to:
receive, from one or more source node devices (106) in communication with the controller (102) via the network (110), a plurality of requests to be transmitted to at least one PLMN cluster;
determine status of each end point associated with the at least one PLMN cluster; and
route, when the status of each said end point associated with the at least one PLMN cluster is determined to be active, the plurality of requests through the at least one PLMN cluster for transmitting it to each said endpoint, wherein the plurality of requests are routed equally to a plurality of endpoints associated with the at least one PLMN cluster based on a routing technique.

2. The system (100) as claimed in claim 1, wherein the controller (102) is configured to route the plurality of requests until the status of the plurality of endpoints become inactive.

3. The system (100) as claimed in claim 1, wherein the controller (102) is configured to determine a number of active endpoints at a predefined time.

4. The system (100) as claimed in claim 3, wherein in case the status of the number of active endpoints is determined to be inactive, the controller (102) is configured to distribute data traffic, pertaining to the plurality of requests in the network (110) proportionally among the remaining number of active end points of said at least one PLMN cluster.

5. The system (100) as claimed in claim 3, wherein in case the status of all the number of active endpoints is determined to be inactive, the controller (102) is configured to send a negative response to the at least one PLMN cluster.

6. The system (100) as claimed in claim 1, wherein the routing technique comprises at least one of: a round robin technique, or a weighted scheduling technique.

7. The system (100) as claimed in claim 5, wherein in case the status of all the number of active endpoints is determined to be inactive, the controller (102) is further configured to stop routing of the plurality of requests to the said inactive endpoints.

8. The system (100) as claimed in claim 1, wherein the controller (102) is further configured to receive a plurality of responses from the plurality of endpoints, the plurality of responses are responses to the plurality of requests received by the plurality of endpoints.

9. The system (100) as claimed in claim 8, wherein the controller (102) is further configured to route the plurality of responses to the one or more source node devices (106) in communication with the controller (102).

10. A method (190) for performing ingress/egress active-active routing in a network (110), the method comprising:
receiving, by a controller (102), from one or more source node devices (106) in communication with the controller (102) via the network (110), a plurality of requests to be transmitted to at least one public land mobile network (PLMN) cluster, wherein the controller (102) is in communication with the at least PLMN cluster associated with a plurality of PLMN clusters, and wherein the at least one PLMN cluster has a plurality of end points associated with the network (110);
determining, by the controller (102), status of each end point associated with the at least one PLMN cluster; and
routing, by the controller (102), when the status of each said end point associated with the at least one PLMN cluster is determined to be active, the plurality of requests through the at least one PLMN cluster for transmitting it to each said endpoint, wherein the plurality of requests are routed equally to a plurality of endpoints associated with the at least one PLMN cluster based on a routing technique.

11. The method (190) as claimed in claim 10, wherein the method further comprises the step of routing, by the controller (102), the plurality of requests until the status of the plurality of endpoints become inactive.

12. The method (190) as claimed in claim 10, wherein the method further comprises the step of determining, by the controller (102), a number of active endpoints at a predefined time.

13. The method (190) as claimed in claim 12, wherein in case the status of the number of active endpoints is determined to be inactive, the method further comprises the step of distributing, by the controller (102), data traffic, pertaining to the plurality of requests in the network (110) proportionally among the remaining number of active end points of said at least one PLMN cluster.

14. The method (190) as claimed in claim 10, wherein the routing technique comprises at least one of: a round robin technique, or a weighted scheduling technique.

15. The method (190) as claimed in claim 12, wherein in case the status of all the number of active endpoints is determined to be inactive, the method further comprises the step of sending, by the controller (102), a negative response to the at least one PLMN cluster.

16. The method (190) as claimed in claim 15, wherein in case the status of all the number of active endpoints is determined to be inactive, the method further comprises the step of stopping routing, by the controller (102), of the plurality of requests to the said inactive endpoints.

17. The method (190) as claimed in claim 10, wherein the method further comprises the step of receiving, by the controller (102), a plurality of responses from the plurality of endpoints, the plurality of responses are responses to the plurality of requests received by the plurality of endpoints.

18. The method (190) as claimed in claim 17, wherein the method further comprises the step of routing, by the controller (102), the plurality of responses to the one or more source node devices (106) in communication with the controller (102).

19. A user equipment (UE) (108) communicatively coupled with a controller (102), said UE (108) configured to:
send a connection request to the controller (102), wherein the UE (108) is operably coupled to the controller (102) via a network (110);
receive an acknowledgment of the connection request from the controller (102);
transmit a plurality of signals in response to the connection request to the controller (102), wherein said controller (102) is in communication with at least one public land mobile network (PLMN) cluster associated with a plurality of PLMN clusters of a system (100), and wherein the controller (102) is configured to:
receive, from one or more source node devices (106) in communication with the controller (102) via the network (110), a plurality of requests to be transmitted to at least one PLMN cluster;
determine status of each end point associated with the at least one PLMN cluster; and
route, when the status of each said end point associated with the at least one PLMN cluster is determined to be active, the plurality of requests through the at least one PLMN cluster for transmitting it to each said endpoint, wherein the plurality of requests are routed equally to a plurality of endpoints associated with the at least one PLMN cluster based on a routing technique.

20. A non-transitory computer readable medium (CRM) comprising a processor with executable instructions, causing the processor to:
receive, from one or more source node devices in communication with a controller (102) via the network (110), a plurality of requests to be transmitted to the at least one public land mobile network (PLMN) cluster;
determine status of each end point associated with the at least one PLMN cluster; and
route, when the status of each said end point associated with the at least one PLMN cluster is determined to be active, the plurality of requests through the at least one PLMN cluster for transmitting it to each said endpoint, wherein the plurality of requests are routed equally to the plurality of endpoints associated with the at least one PLMN cluster based on a routing technique.
